(19) United States
(12) Patent Application Publication
(10) Pub. No.: US 2004/0095520 A1
(43) Pub. Date: May 20, 2004

(54) PANEL PROTECTION DEVICE FOR A LIQUID CRYSTAL DISPLAY PANEL

(76) Inventors: Shien-Yuan Lin, Taipei City (TW); Meng-Ru Yu, Taipei City (TW); Wei-Renn Chen, Taipei City (TW); Mao-Jung Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,216

(22) Filed: Mar. 24, 2003

(30) Foreign Application Priority Data
Nov. 18, 2002 (TW) 091133634

(51) Int. Cl. G02F 1/1333

(52) U.S. Cl. 349/58

(57) ABSTRACT

A panel protection device for accommodating a panel includes a base, a frame fastened to the base, and a monolithic film having an inner edge and an outer edge. The inner edge of the monolithic film is attached to the panel and the outer edge is attached to the frame. The panel is accommodated between the inner edge of the film and the base.

### BACKGROUND OF INVENTION

1. Field of the Invention

The invention relates to a panel protection device, more specifically, a panel protection device used in a notebook.

2. Description of the Prior Art

Personal computers (PCs) have become indispensable tools in daily life. In recent years, for uses ranging from E-mail to document arrangement to product presentation . . . etc., PCs are popular devices in people's lives. However, disadvantages of a general desktop, such as a huge volume and a heavy weight, result in inconveniences regarding mobility. Fortunately, notebooks satisfy people's desire for taking computers along with them anytime. Compared with a traditional Cathode Ray Tube (CRT) widely used in a desktop computer in the past, a liquid crystal display (LCD) for a notebook, due to its small volume, light weight, low power consumption, and low radiation, is adapted for portability. Though notebooks are thinner and lighter than initial counterparts, manufacturers still do their best to reduce the size, weight, and costs of the notebook.

However, because the most widely used size of present LCD panels is in a range of 13˜15 inches, it is expensive to open various molds for various sizes of panel protection devices which are used to accommodate the LCD panels. In addition, if the panel protection device is required to be painted multiple colors, due to injection molding results in one color, the panel protection device needs at least two parts with different colors. For example, if the manufacturer wants to manufacture a panel protection device whose outer edge is black and inner edge is white, due to typical injection molding allowing for only a single color, the manufacturer has to have two molds for producing an outer edge with black and an inner edge with white and then to assemble them. In this way, the above method causes extra expense for tooling additional molds.

Please refer to FIG. 1 and FIG. 2. FIG. 1 is a schematic diagram of a conventional panel protection device 10 for accommodating an LCD 16. FIG. 2 is a cross-sectional view of the panel protection device 10 along the line 2-2. The panel protection device 10 includes a base 12 and a frame 14 fastened to the base 12. The LCD 16 is accommodated between the frame 14 and the base 12. During the process of modeling the frame 14, current techniques limit the thickness of the frame 14 to at least 1.3 mm. If thinner than 1.3 mm, the frame 14 is easily split. If intending to change the color of the frame 14, it is necessary to re-paint or to manufacture another mold for producing a matching device. This causes an additional expense.

### SUMMARY OF INVENTION

It is therefore a primary objective of the claimed invention to provide a panel protection device capable of reducing the thickness and adjusting the width of the panel protection device for accommodating the various sizes of LCD panels.

Briefly summarized, the panel protection device of the claimed invention for accommodating a panel includes a base, a frame fastened to the base; and a monolithic film having an inner edge attached to the panel and an outer edge attached to the frame. The panel is accommodated between the inner edge and the base.

It is an advantage of the claimed invention that manufacturer is can manufacture a single sized frame with an adjustable width of the film attached thereto, forming the panel protection devices for accommodating various sizes of LCD panels.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a panel protection device according to prior art.

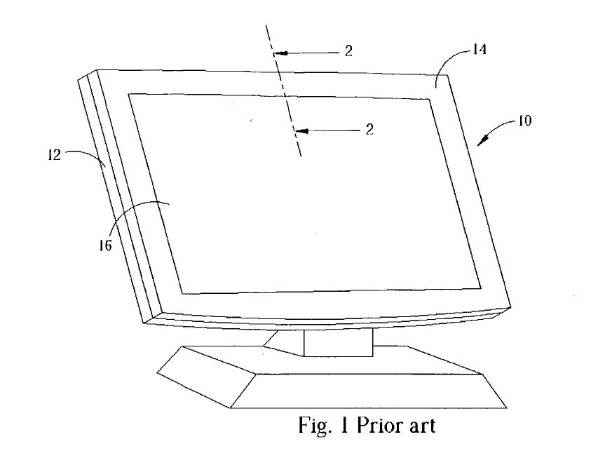

FIG. 2 is a cross-sectional view of the panel protection device illustrated in FIG. 1 along the line 2-2.

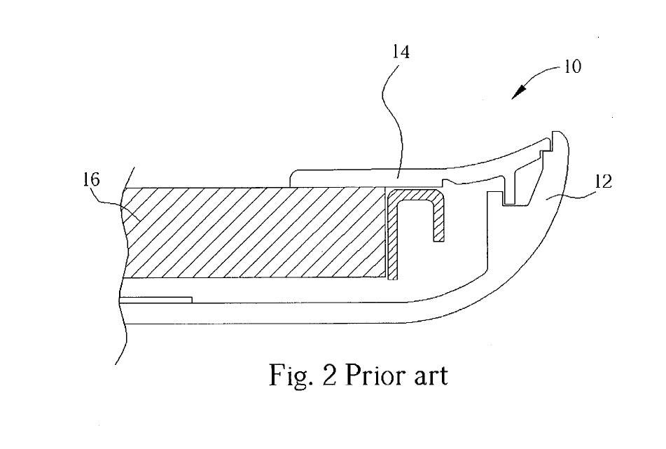

FIG. 3 is a schematic diagram of a panel protection device according to the present invention.

FIG. 4 is a cross-sectional view of the panel protection device illustrated in FIG. 3 along the line 4-4.

FIG. 5 is a schematic diagram of forming the panel protection device illustrated in FIG. 4.

### DETAILED DESCRIPTION

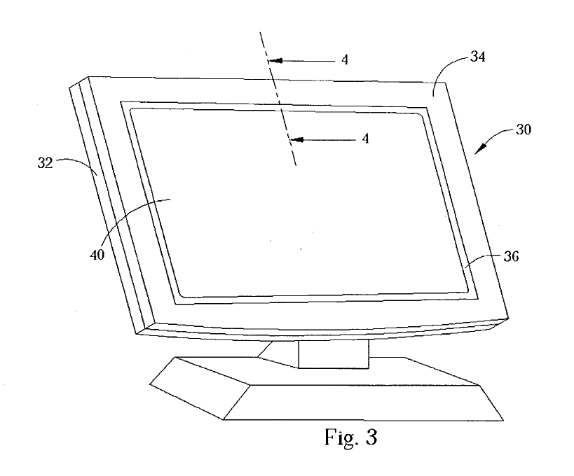

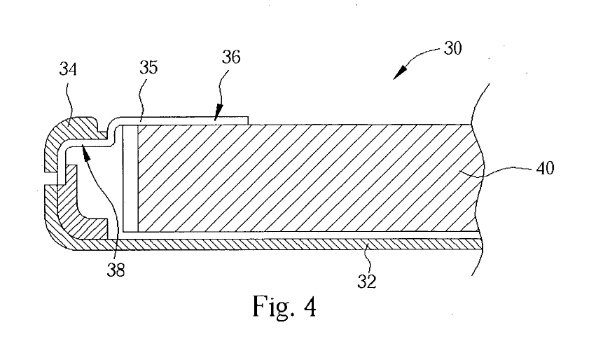

Please refer to FIG. 3 and FIG. 4. FIG. 3 is a schematic diagram of a panel protection device 30. FIG. 4 is a cross-sectional view of the panel protection device 30 along the line 4-4. The panel protection device 30 is for accommodating an LCD 40 connected to a notebook. The panel protection device 30 includes a base 32, a frame 34 fastened to the base 32, and a monolithic film 35 having an inner edge 36 and an outer edge 38. The inner edge 36 is attached to the panel 40, and the outer edge 38 is attached to the frame 34. The panel 40 is accommodated between the inner edge 36 and the base 32. The base 32, the frame 34, and the film 35 are all of plastic material.

Traditionally, the prior art panel 16 is accommodated between the frame 14 and the base 12. Due to limitations with respect to modeling the frame 14, the thinnest practical thickness of the monolithic frame 14 is 1.3 mm and therefore the thickness of the panel protection device 10 adds at least 1.3mm. For making the thickness thinner, in this embodiment, the panel 40 is accommodated between the base 32 and the inner edge 36 of the film 35 whose thickness is less than 1.3mm. In this way, the whole thickness of the panel protection device 30 is less than that of the conventional panel protection device 10.

In addition, if the size of the panel 40 is smaller, the inner edge 36 of the selected film 35 needs broadened to protect the panel 40. For example, if a 13-inch panel 40 is selected and the original design of the panel protection device 30 is for accommodating a 15-inch panel 40, a broader inner edge 36 of the film 35 is needed in order to extend the inward rim of the panel protection device 30 for fixing the panel 40. On the other hand, if a 15-inch panel 40 is selected, the inner edge 36 of the panel 40 does not need too broad a rim to fix the panel 40. Certainly, the inner edge 36 of the film 35 can be painted desired color in advanced giving the panel protection device 30 diverse appearances.

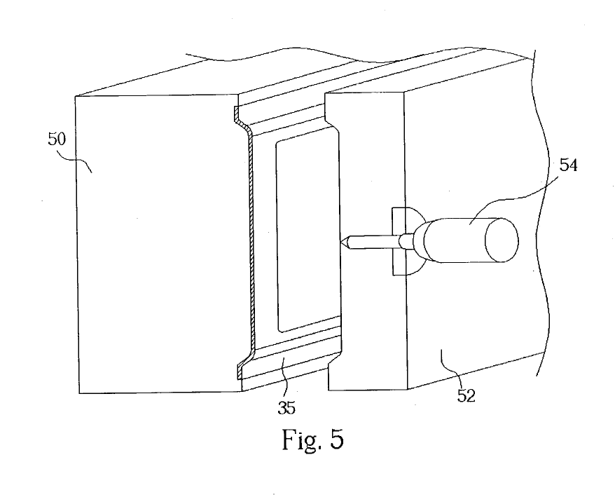

Please refer to FIG. 5, which shows a schematic diagram of forming the panel protection device 30 illustrated in FIG. 4. While intending to form the frame 34 and attach the film 35 thereon, the film 35 is placed on a male mold 50. Then, seal a female mold 52 and the male mold 50. Inject a plastic compound from a tube 54 to mold the frame 34 and make the outer edge 38 of the film 35 attach to the frame 34. The frame 34 with the film 35 is capable of being fastened with the base 32. There is a space, between the base 32 and inner edge 36 of the film 35, for accommodating the panel 40.

In contrast to prior art, the present invention makes the panel protection device thinner; moreover, additional design molds for various sizes of the panel protection devices are not needed anymore. If the manufacturer intends to manufacture various sizes of panel protection devices for accommodating various sizes of panels, just appropriate molds are required for manufacturing single-size frames of the panel protection devices which are capable of adjusting the width of the film attached to the frames for accommodating the various sizes of the panels. Moreover, the film can be painted in advance, making the appearance of the frame multi-colored.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A panel protection device for accommodating a panel comprising:
a base;
a frame fastened to the base; and
a monolithic film having an inner edge attached to the panel and an outer edge attached to the frame;
wherein the panel is accommodated between the inner edge and the base.

2. The panel protection device of claim 1 wherein the panel is a liquid crystal display panel (LCD panel).

3. The panel protection device of claim 1 wherein the thickness of the film is less than 1.3 mm.

4. The panel protection device of claim 1 wherein the base is made of plastic material.

5. The panel protection device of claim 1 wherein the frame is made of plastic material.

6. The panel protection device of claim 1 wherein the film is made of plastic material.

7. The panel protection device of claim 1 wherein the panel is used in a notebook (NB).

8. A method of forming a panel protection device comprising:
positioning a film on a male mold;
sealing a female mold and the male mold and injecting plastic thereinto to attach an outer edge of the film onto a frame;
fastening the frame onto a base; and
accommodating a panel between the inner edge of the film and the frame.

9. The method of claim 8 wherein the panel is a liquid crystal display panel (LCD panel).

10. The method of claim 8 wherein the thickness of the film is less than 1.3 mm.

11. The method of claim 8 wherein the base is made of plastic material.

12. The method of claim 8 wherein the frame is made of plastic material.

13. The method of claim 8 wherein the film is made of plastic material.

14. The method of claim 8 wherein the panel is used in a notebook (NB).
